(19) United States
(12) Patent Application Publication
(10) Pub. No.: US 2004/0066908 A1
(43) Pub. Date: Apr. 8, 2004

(54) Method and device for the representing an object by means of an irradiation and for reconstructing said object

(76) Inventors: Randolf Hanke, Puschendorf (DE); Stefan Schropfer, Oberasbach (DE); Heinz Gerhaeuser, Waischenfeld (DE); Dietrich Paulus, Herzogenaurach (DE)

Correspondence Address: GLENN PATENT GROUP, 3475 EDISON WAY, SUITE L, MENLO PARK, CA, 94025, US

(21) Appl. No.: 10/399,224

(22) PCT Filed: Oct. 11, 2001
(86) PCT No.: PCT/EP01/11796

(30) Foreign Application Priority Data
Oct. 11, 2000 (DE) 100 50 250.4

(51) Int. Cl. G21K 1/12

(52) U.S. Cl. 378/901; 378/4

(57) ABSTRACT

The invention is based on the knowledge that a representation of an object can be improved via a transmission with regard to a subsequent reconstruction of the object based on the representation, by using simulated data, which correspond to a simulated transmission of the object already prior to a reconstruction as advance information for measuring a transmission of the object and/or for generating the representation from a measured transmission. An inventive method for the representation of an object via a transmission comprises providing simulated data, which correspond to a simulated transmission of the object, for example in a memory, and using the simulated data for measuring a transmission of the object, for example in a computertomograph, to obtain the transmission of the object, by a control and/or using the simulated data for generating the representation from a measured transmission by a data preparation means.

### BACKGROUND OF THE INVENTION

1. Field of the Invention

The present invention refers to the representation of objects via a transmission and to the reconstruction of an object based on such a representation of the object, such as it is the case in computer tomography.

2. Description of Prior Art

Computer tomography has been developed in the 70 ties and is based on the reconstruction of an object based on projections of the object from different transmission directions. Every projection level gives information about an absorption and extinction distribution, respectively, of the object transversal to the transmission direction. The object can be determined with regard to its extinction properties and its density, respectively, from the projections of different transmission directions.

In an X-ray computer tomograph, for example, an X-ray tube and an X-ray detector opposite to the X-ray tube across the object, which consists of a row and a circle segment of sensors, respectively, rotate around the object. The X-ray tube radiates through the object via a radiation fan, wherein the rays radiating through the object are received from the sensors of the X-ray detector. This process is repeated for different transmission directions, wherein the level of rotation and the level of the radiation fan always run parallel to each other. In the reconstruction of the object based on the obtained projection data, a cut image or projection through the object is generated. By a relative displacement of the computer tomograph to the object perpendicular to the rotation level, subsequent adjacent cut images are generated, from which a three-dimensional image of the object can be generated. In modern X-ray computer tomographs of the spiral computer tomography technique, the relative displacement of the object to the computer tomograph and the rotation movement of the X-ray tube/X-ray detector arrangement are preformed continuously, so that the reconstruction of the object is not performed cut-image-wise but spiral-shaped.

In FIG. 3, a conventional arrangement for the reconstruction of an object based on computer tomography data is shown. The computer tomograph 900 receives measuring parameters 902 at an input, which, for example, determine the radiation directions, intensities and exposure times to be used during a measurement of an object 903, which is generally shown in FIG. 3 as a circle. The computer tomograph measures the transmissions of the object according to defaults of the measuring parameters 902 and outputs the measured data, which comprise projection data of transmissions of different transmission directions, as reconstruction values 904 to the reconstruction means 906. The reconstruction means 906 reconstructs image data 908 from the reconstruction data, which correspond to an image of the object and contain, for example, material density information of the object 903.

It is one problem of computer tomography that, when the object 903, such as an industrial device under test has a combination of a high absorption density on the one hand and a large radiation path on the other hand, such as when strongly absorbing material lands are present in the device under test, even in a small part of the radiation directions necessary for the reconstruction means 906 for computer tomographical reconstruction, this high absorption often leads to unmeasurably low intensities and consequently to erroneous and incomplete projection data, respectively, in the reconstruction data 904 due to the limited usable detector dynamic of the computer tomograph 900. This faulty portion of the measuring data leads to characteristic artifacts in the images data 908 in the computer tomographical reconstruction in the reconstruction means 906, which are not locally limited to the areas of high density. In a quality test of a device under test, these artifacts can, for example, prevent the detection of material faults in other areas than those of high absorption density. Generally, due to these artifacts, any subsequent automatic image evaluation of the image data 908 with the aim of error recognition is seriously impeded.

In the past, it has been attempted to avoid this artifact problem, which arises by the incomplete and faulty reconstruction data 904, respectively, by simply omitting of the reconstruction data 904, wherein non-local artifacts, such as cylindrical areas with missing material density information, which are in their shape object dependent, are formed in the reconstructed image 908, so that the reconstruction is affected as a whole. The partly missing projection data had to be treated by specialized reconstruction algorithms in the reconstruction. Additionally, the missing areas in the reconstructed image increase the effort for the following error recognition based on the reconstructed image.

### SUMMARY OF THE INVENTION

It is the object of the present invention to provide a method and an apparatus for the representation of an object via a transmission, so that the representation is better suited for a subsequent reconstruction of the object, and/or so that the transmission of the object is less expensive.

In accordance with a first aspect of the present invention this is achieved by a method for representation of an object via a transmission, the method comprising providing simulated data, which correspond to a simulated transmission of the object, and using the simulated data for measuring a transmission of the object to obtain the transmission of the object by setting a measuring parameter of a measuring means, which is adapted to measure a transmission of the object depending on the measuring parameter, based on the simulated data, to obtain measured data, which correspond to the measured transmission, characterized in that the setting of the measuring parameter is performed based on an evaluation of the simulated data aimed at a radiation dose radiated on the object by the measuring means being as low as possible.

In accordance with a second aspect of the present invention this is achieved by an apparatus for representation of an object via a transmission, comprising a means for providing simulated data, which correspond to a simulated transmission of the object; and means for using the simulated data for measuring a transmission of the object to obtain the representation of the object, wherein means for using comprises means for setting a measuring parameter of a measuring means, which is adapted to measure a transmission of the object depending on the measuring parameter, based on the simulated data, to obtain measured data, which correspond to the measured transmission, characterized in that said means for setting comprises an evaluation means, wherein said means for setting performs the setting based on an evaluation of the simulated data by the evaluation means which is aimed at a radiation dose radiated onto the object by the measuring means being as low as possible.

The invention is based on the knowledge that a representation of on object via a transmission can be improved with regard to a subsequent reconstruction of the object based on the representation by using simulated data, which correspond to a simulated transmission of the object already prior to a reconstruction, as advance information for measuring a transmission of the object and/or for generating the representation from a measured transmission.

It is an advantage of the present invention that it makes it possible to determine data from objects via transmission so that a reconstruction is also possible where conventional methods lead to artifacts.

According to a first aspect of the present invention, simulated data are used for measuring a transmission or through-radiation of the object. According to one embodiment, advance information and a model of the object, respectively, such as a CAD model of a target or desired construction of a device under test, are used already prior to data capture and measuring the object, res., to simulate simulated transmissions of the object from, for example, several transmission directions, to generate the simulated data. These simulated data can than be evaluated to optimize the measuring parameters of a measuring means, such as a computer tomograph, which measures a transmission of the object. Thus, it is, for example, possible to determine one and several, respectively, better or optimum transmission directions and one or several improved or optimum direction-dependent intensities and exposure lengths based on the simulated data. The improvement or optimization can be performed, for example, such that the determined measuring parameters keep the artifacts in a reconstruction of the object basing on the measured data as low as possible. The measuring parameter setting can, for example, be improved or optimized to keep the number of transmission directions with adverse transmission conditions and high absorption, respectively, as low as possible. Another possible improvement intends that a radiation dose applied to the object by the measuring means is as low as possible, or that an optimal tradeoff with regard to a measuring period and a detector dynamic of the measuring means is made. Accordingly, by these improvement and optimization measures, respectively, either the measured data can be improved with regard to the subsequent reconstruction and/or the transmission effort can be reduced.

According to another aspect of the present invention, simulated data, which correspond to a simulated transmission of the object, are used to generate the representation of the object from a measured transmission. According to an embodiment, simulated data, which correspond to a simulated transmission of the object, are used to supplement and/or replace measured data, which correspond to a measured transmission of the object, as it is generated, for example, by a computer tomograph, partly with the simulated data prior to a subsequent reconstruction of the object based on the measured data. In transmission directions, for example, which generate areas of very high absorption and thus faulty areas in the measured data, despite optimum setting of the measuring parameters and optimum planning of the measuring geometry, the areas in the projection data, which are highly noisy and inaccurate due to the high absorption, are replaced by simulated data, which are, for example, captured from a CAD model of the device under test. On the other hand, a transmission direction required for the reconstruction can be omitted from the beginning because of an optimization of the measuring parameters, wherein the measured data are later supplemented with simulated data, which correspond to a simulated transmission in this direction. By this usage of simulated data for supplementing and replacing of bad or maybe generally unmeasured data prior to the reconstruction, artifacts in the reconstruction, which can arise through a lacking detector dynamic, can be mostly avoided, whereby a detectability of material errors based on the reconstructed image of the object is maximized. Above that, areas with faulty material density information in the image data generated in the reconstruction, as they have been generated by the conventional omission of data, are avoided by replacing and supplementing the measured data.

Further preferred embodiments of the present invention are defined in the accompanying claims.

### BRIEF DESCRIPTION OF THE DRAWINGS

Preferred embodiments of the present invention will be discussed in more detail below with reference to the accompanying drawings. They show:

FIG. 1 an apparatus for the reconstruction of an object with a measuring control and data preparation module according to an embodiment of the present invention;

FIG. 2 a flow diagram illustrating the mode of operation of the apparatus of FIG. 1 based on steps according to an embodiment of the present invention; and

FIG. 3 a conventional construction for a computer tomographical reconstruction.

### DESCRIPTION OF PREFERRED EMBODIMENTS OF THE INVENTION

It should be noted that the following description of the present invention refers merely exemplarily to an embodiment, wherein the transmissions of the object are performed via an X-ray computer tomograph, and wherein the object to be tested is a device under test, such as an artificial limb to be tested. The invention can be applied, for example, to other computer tomography methods, such as positron emission tomography (PET) or to other transmission methods, wherein advance information and previous knowledge, respectively, can be used for the optimization of the setting of the adjustment of measuring parameters or for the subsequent supplementation and replacement of the measured data for an improvement of a subsequent reconstruction.

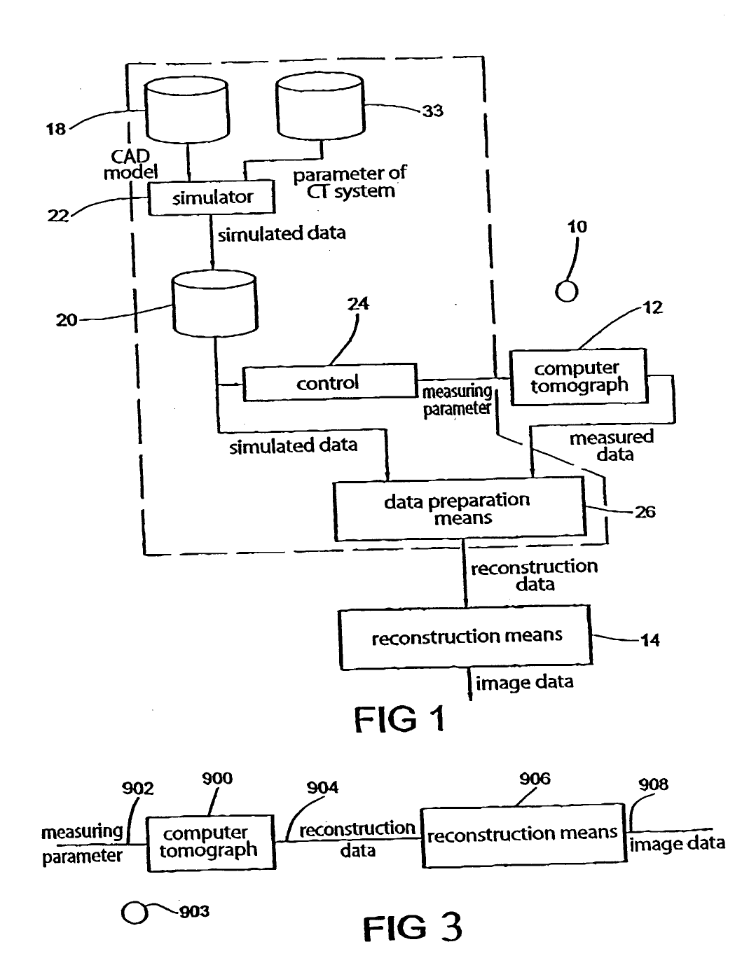

FIG. 1 shows the construction of an apparatus for a computer tomographical reconstruction of an object according to an embodiment of the present invention. According to the present embodiment, the apparatus is provided to test a device under test 10, such as an artificial limb, for example for a deviation from the target construction or for other faults, such as cracks or the like.

The apparatus of FIG. 1 comprises a computer tomograph 12, a reconstruction means 14 as well as a measuring control and data preparation module 16. The measuring control and data preparation module 16 is connected to an input of the computer tomograph 12 to supply measuring parameters to it, which determine the measuring conditions during a measurement of the computer tomograph 12 at the object 10. The measuring control and data preparation module 16 is further connected to an output of the computer tomograph 12, to obtain the measured data from the computer tomograph 12, i.e. the measured projection data of the object 10, which are obtained in the transmission of the object 10 by using the determined and set measuring parameters, respectively, such as the set transmission directions, intensities and exposure time periods. The measuring control and preparation module 16 outputs reconstruction data at an output to the reconstruction means 14, based on which the reconstruction means 14 generates image data, which correspond to an image of the object 10, and contain, for example, material density information about the object 10.

The measuring control and data preparation module 16 comprises two memories 18 and 20, a simulator 22, a control 24 and a data preparation means 26. The simulator 22 is connected to the two memories 18 and 20 such that is has read access with regard to the memory 18 and write access with regard to the memory 20. The control 24 and the data preparation means 26 are connected to the memory 20, such that they are able to access the content of memory 20. An output of the control 24 is connected to an input of the computer tomograph 12, while the data preparation means 26 comprises an input, which is connected to the output of the computer tomograph 12, and an output, which is connected to the input of the reconstruction means 14. In a way, which will be discussed below, the control 24 and the measuring control and data preparation means 26 use the information available in the memory 20 to determine optimized measuring parameters for the computer tomograph 12 and output them to it, and to supplement and to replace measured data from the computer tomograph 12, respectively, and to output them as reconstruction data to the reconstruction means 14.

The computer tomograph 12 comprises internally (not shown) an X-ray emitter, such as an X-ray tube, which has a certain primary X-ray spectrum, and an X-ray detector, which has a certain detector characteristic and a frequency dependent sensitivity, respectively, and a certain maximum detector dynamic.

Subsequent to the reconstruction means 14, there can, for example, be a quality test means (not shown), which determines faults or other deviations of the device under test 10 from a target shape or a target construction based on the image data generated by the reconstruction means 14.

Before the mode for operation of the apparatus of FIG. 1 will described below, it should be noted that the internal partitioning of the measuring control and data preparation module 16 can be different than illustrated. Particularly, it should be noted, that the individual elements, i.e. the simulator 22, the control 24, the data preparation means 26 and the reconstruction means 14 can be realized in software, firmware or hardware. They can, for example, be formed as an integrated circuit (IC), an ASIC (application specific IC), a programmable logic, a software program or a combination of those.

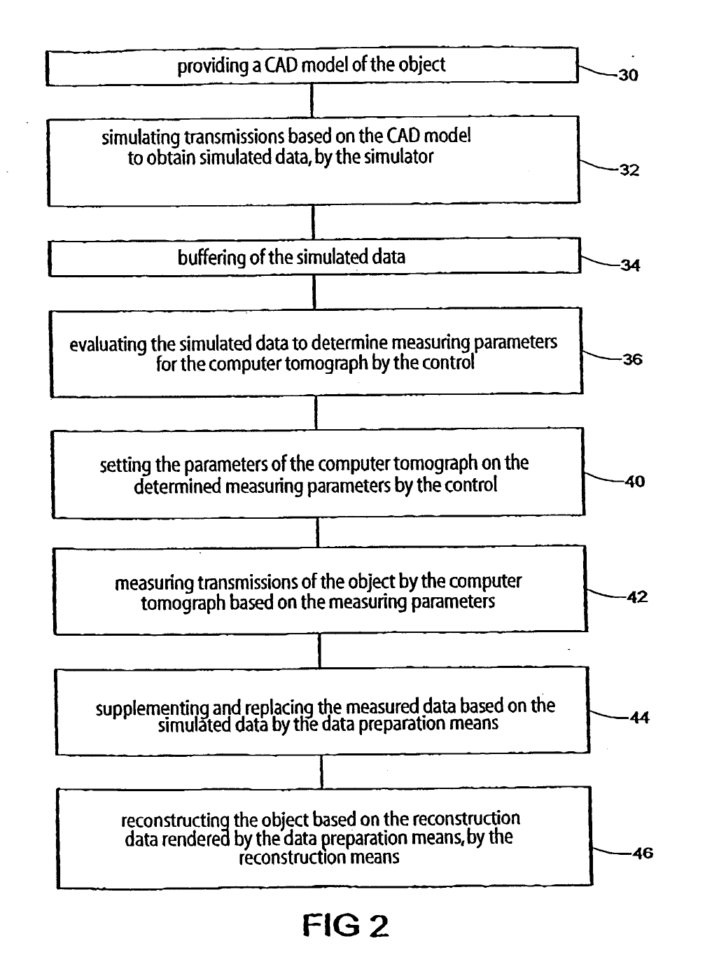

After the construction of the apparatus of FIG. 1 has been described above, its mode of operation will be described below with reference to the steps shown in FIG. 2 according to an embodiment of the present invention, wherein reference will still be made to FIG. 1.

First, in a step 30, a model of the device under test 10 is provided in memory 18. The model data of the device under test 10 are provided, for example, in the form of CAD (CAD=computer aided design) data or in form of raster and pixel data, respectively, which indicate local material densities and other material properties. The model data can be three-dimensional or two-dimensional. Particularly, the model of device under test 10 contains information about a target geometry and the used materials or the transmission properties of the device under test 10. In the case of a massive form part, the CAD data of the device under test 10 comprise, for example, merely information about the outer shape and the used material of the device under test 10. The model of the object 10 provided in step 30 can, for example, also consist of a previously made CT reconstruction, either of the object 10 itself or of representative good part.

In a step 32, the simulator 22 accesses the memory 18, to obtain the model of the device under test 10, and simulates transmissions of the device under test 10 based on the model to obtain simulated data. The simulation is performed, for example, under consideration of the extinction law with based on the information coming from the CAD data in the memory 18 about the extinction properties of the object 10. In the present embodiment, the simulator 22 performs transmissions in several transmission directions, so that the simulated data contain a simulated projection data, which correspond to simulated transmissions in different transmission directions. In the simulation of the transmissions of the device under test 10 in the different projection angle and transmission directions, respectively, apart from the target data of the device under test 10, which are defined by the CAD model in the memory 18, the knowledge, for example of parameters of the CT system 12 provided in another memory, such as the transmitted primary X-ray spectrum of the X-ray emitter of the computer tomograph 12 and the detector characteristic of the X-ray detector of the computer tomograph 12 as well as the measuring geometry, will be used.

In a step 34, the simulated data will be buffered in the memory 20, to retrievably provide them for the control 24 and the data preparation means 26. The simulated data are stored in the memory 20, for example by using the projection angle used in the simulation as an index.

In a step 36, the control 24 accesses the memory 20 to evaluate the simulated data to determine measuring parameters for the computer tomograph 12. The evaluation of the simulated data and determination of the measuring parameters for the computer tomnograph 12 serve for the planning of the measuring of the transmissions, which are to be performed by the computer tomograph 12, and which serve as a base for the subsequent computer tomographical reconstruction, which is to be performed in the reconstruction means 14. The measuring parameters determined in step 36 define, for example, a set of transmission directions, X-ray extensities and/or exposure times, which the computer tomograph 12 is to use in the transmissions of the device under test. The determination of the measuring parameters can either be performed based on a selection of the appropriate measuring positions and transmission directions, respectively, or the position-dependent exposure times from a set of measuring positions and exposure times, respectively, used in the simulation in step 32.

The evaluation 36 of the simulated data to determine the measuring parameters for the computer tomograph 12 can be set to optimize the measuring parameters in different ways. In the evaluation 36, the measuring parameters are, for example, determined such that the artifacts, which result from lacking information in the measured data, caused by an object absorption too high and lacking detector dynamic, respectively, are reduced in the subsequent computer tomographical reconstruction. The reduction of the artifacts in the subsequent computer tomographical reconstruction can particularly be achieved when those transmission directions with particularly high absorption due to the limited dynamic of the X-ray detector of the computer tomograph 12 are mostly avoided in determining the transmission directions. The evaluation of the simulated data obtained from the CAD model by simulation can further be laid out such that the measuring process of the computer tomograph 12 such that the radiation dose to which the device under test 10 is subjected during the measuring process, is reduced. Above that, the information won from the CAD models can be used for the control of the exposure time and the X-ray intensity, respectively, during the computer tomography measurement by the computer tomograph 12, to make the best possible tradeoff with regard to measuring time and utilized detector dynamic.

The reduction of the artifacts in the computer tomographical reconstruction and in the image data subsequently generated by the reconstruction means 14, respectively, enables, if necessary, a simpler subsequent automatic image data evaluation, such as a quality test, based on the image data. Further, in step 36, the measurement of unnecessary or, due to lacking detector dynamic, unuseful and incomplete projection data, respectively, of the device under test 10 can already be identified and prevented and omitted, respectively, prior to data capturing by the computer tomograph 12 based on the simulated data.

In step 40, the control 24 sets the measuring parameters of the computer tomograph 12 to the determined measuring parameters. The transmission of the measuring parameters to the computer tomograph 12 can be performed, for example, in one piece for all transmission directions, or it can be performed individually for every transmission direction. Above that, the control can be performed analog or digital.

In a step 42, the computer tomograph 12 measures the transmission of the device under test 10 based on the measuring parameters, which it receives from the control 24. Depending on the optimization of the evaluation of the simulated data in the step 36, and the determination of the measuring parameters, respectively, the radiation dose, to which the device under test 10 is subjected in the transmissions, is minimal, the number of transmissions with a high absorption and thus the faulty portion of the measured data, which lead to artifacts in the subsequent reconstruction, is minimal, or a best possible tradeoff with regard to measuring duration and utilized detector dynamic has been made.

In a step 44, the data preparation means 26 receives the measured data from the computer tomograph 12 and supplements and replaces the measured data based on the simulated data provided in the memory 20. The measured data of the computer tomograph 12 comprise measured projection data, which have been obtained from transmissions of the device under test 10 by using the transmission directions, position dependent exposure times and X-ray intensities determined by the measuring parameters. If now, for example, the control 24 has determined in step 36 in a certain transmission direction, that it has, on the one hand, a absorption density too high and, on the other hand, a radiation path too high, so that the detector dynamic would not be sufficient in this transmission direction, and it has therefore omitted this transmission direction in step 36 in the control of the computer tomograph 12, the data preparation means 26 can supplement the measured data with the missing projection data of this transmission direction by the respective simulated data. For the transmission directions, which have lead to measured data, which contain areas of very high absorption despite optimum setting and planning, respectively, of the capturing geometry, the data preparation means 26 can replace the areas in the projection data of the measured data, which are, for that reason, inaccurate and highly noisy, by the respective simulated data in the step 44. The thus changed data are output by the data preparation means 26 to the reconstruction means 14 in step 44.

The supplementing and replacing of the measured date performed in step 44 leads to the fact that artifacts are reduced as far as possible by the reconstruction means 14 in the subsequent reconstruction, and that the detectability of material faults based on the reconstructed image data, which are subsequently generated by the reconstruction means, is increased, since the reconstruction has less faults than in conventional methods.

In step 46, the reconstruction means 14 receives the reconstruction data from the data preparation means 26 and performs a reconstruction of the device under test 10 based on them and outputs the generated image data. The reconstruction is performed in an conventional manner, but, however, the number of artifacts are reduced with the help of the measuring control and data preparation module 16 in the generated image data, which correspond to an image of the device under test 10 and contain, for example, density and material information about the device under test 10, and above that, they have no artifacts, as it is the case in the image data generated by computer tomography measuring data in conventional manner.

Thus, the embodiment described above with reference to FIGS. 1 and 2, provides a fast measuring planning of projection data for the computer tomography by appropriate evaluation of CAD model data of an object to be tested. The integration of the CAD models of the object to be tested already prior to reconstruction and prior to date capture, respectively, is a base therefore. Unnecessary or, due to lacking detector dynamic, unuseful and incomplete project data, respectively, of the object to be tested can already be identified prior to the data capture from the CAD data by simulated X-ray projections, and can be replaced by data simulated with the help of the CAD modules for the reconstruction. Projection angles, from which, due to insufficient detector dynamic, no valuable signal is expected, are thus replaced by simulated data. For all other position angles, real X-ray projections are generated in a realization with the object to be tested. In other words, a supplementation of incomplete radion data sets is obtained with the help of CAD models. Generally, a production of simulated X-ray transmissions of a device under test is performed, to use the knowledge about devices under test gained in that way in a plurality of ways for the computer tomography. As a result, the detectability of faults due to the prevention of non-local artifacts is increased by introducing previous knowledge about the devices under test.

Since an embodiment for the construction and the mode of operation of the apparatus of FIG. 1 has been described above with reference to FIGS. 1 and 2, different alternatives, which are possible according to the invention, will be pointed out below. First, it should be noted that, as it has been mentioned above, the invention is not only applicable to X-ray computer tomography. Particularly, the present is not limited to the type of utilized radiation. Generally, the present invention can be applied to all areas where a representation of an object is performed via a transmission.

With regard to steps 30 to 34, it should be noted that the simulated data could also be provided in a different way. The step 34, for example, can be missing, wherein instead the simulation by using certain simulation parameters would be performed again. On the other hand, an intermediate storage of the determined measuring parameters could be performed between step 36 and 40, to avoid a repeated evaluation of the simulated data in the case, where several devices under test of the same type are to be tested. Although the evaluation of the simulated data is performed in step 36 such that the measuring parameters determine a whole measuring process of the device under test 10, it is further possible to perform the steps 36 and 40 subsequently individually, for example for subsequent transmission directions. In this case, the simulated data underlaying the evaluation in step 36 could correspond merely to a simulated transmission in the one transmission direction. The simulation based on the model could also be performed to a later time. Additionally, it would be possible to perform the simulation of the model data in another way, or let it be performed, respectively, so that it is missing, and process directly based on simulated data. Particularly, the transmission intensity can be regulated during the transmission process depending on the simulation results, which is used in medical applications for minimizing the radiation dose.

Further, the model of the object can be dynamically adapted during the running operation. An initial default of a model can thus be adapted to actual conditions by individual projections.

Further, it should be noted that different to the illustration in FIGS. 1 and 2, either steps 36 and 40 and the control 24 or step 44, respectively, and the data preparation means 26, could be omitted. In the first case, the computer tomograph 12 would obtain default measuring parameters as usual, to perform the measurement of the transmissions at the devices under test, which have not been optimized in any way based on simulated data. However, the measured data of the computer tomograph would be partly supplemented by the simulated data and/or replaced with the simulated data by the data preparation means 26, wherein, as described above, a reduction of artifacts in the image data reconstructed subsequently by the reconstruction means occurs. In the other case, the computer tomograph would output its measured data directly to the reconstruction means 14. The measuring parameters, based on which the computer tomograph performs the measurements at device under test, would be, however, optimized by the control based on the simulated data, such as with regard to a minimum radiation dose, a minimum number of artifacts in the subsequent reconstruction or the like, as it has been described above, so that the measured data, based on which the reconstruction is performed, would be improved. In both alternative cases, the measuring control and data preparation module, respectively, would consequently generate a representation of the object, which improves a subsequent reconstruction of the object, namely in the one case on measuring data and reconstruction data, respectively, partly replaced by simulated data and partly supplemented by simulated data and in the other case optimized measuring data, which have been captured under optimized measuring conditions, which are determined by measuring parameters, which are optimized by using the simulation results.

Further, it should be noted that the above-described embodiment could further be used for medical applications, for example to reduce artifacts, such as metal artifacts, caused by implants. Therefore, a CAD model of an implantate is to be combined with an adequate anatomical model in the CAD model. In the same way, instead of the above-described device under test 10 any object to be tested is possible. Particularly, the present invention is applicable both in the industrial and in the medical computer tomography.

What is claimed is:

1. A method for representation of an object (10) via a transmission, comprising:
providing simulated data, which correspond to a simulated transmission of the object; and
using (36, 40) the simulated data for measuring a transmission of the object to obtain the transmission of the object by setting a measuring parameter of a measuring means, which is adapted to measure a transmission of the object depending on the measuring parameter, based on the simulated data, to obtain measured data, which correspond to the measured transmission, characterized in that the setting of the measuring parameter is performed based on an evaluation of the simulated data aimed at a radiation dose radiated on the object by the measuring means being as low as possible.

2. The apparatus for representation of an object via a transmission, comprising:
means for providing simulated data, which correspond to a simulated transmission of the object; and;
means for using the simulated data for measuring a transmission of the object to obtain the representation of the object, wherein means for using comprises means for setting a measuring parameter of a measuring means, which is adapted to measure a transmission of the object depending on the measuring parameter, based on the simulated data, to obtain measured data, which correspond to the measured transmission, characterized in that said means for setting comprises an evaluation means, wherein said means for setting performs the setting based on an evaluation of the simulated data by the evaluation means which is aimed at a radiation dose radiated onto the object by the measuring means being as low as possible.

3. The apparatus according to claim 2, wherein means for providing simulated data comprises:
means for providing a model of the object, which comprises information about a geometry and a transmittability of the object; and
means for simulating a transmission of the object based on the model of the object to obtain the simulated data.

4. The apparatus according to claim 2, wherein the measuring parameter is one of a group of parameters, comprising a transmission direction, an exposure time and a radiation intensity.

5. The apparatus according to claim 2, wherein simulated data correspond to a plurality of simulated transmissions of the object with different transmission directions, which correspond to measured data of a plurality of measured transmissions of the object with different transmission directions, and the measuring parameter comprises a set of a transmission direction, exposure time and radiation intensity for different transmission directions.

6. The apparatus according to claim 2, wherein means for using comprises:
means for replacing at least a part of the measured data, which correspond to the measured transmission, by a respective part of the simulated data, to obtain reconstruction data.

7. The apparatus according to claim 2, wherein means for using comprises:
means for supplementing measured data, which correspond to the measured transmission, by at least part of the simulated data, to obtain reconstruction data.

8. The apparatus according to claim 6, wherein the measured data correspond to a plurality of measured transmissions.

9. The apparatus according to claim 6, wherein the replaced measured data or the supplemented reconstruction data correspond to transmissions, wherein a high absorption occurs by the object.

10. vapparatus according to claim 2, further comprising:
means for outputting at least the measured data or the reconstruction data to a reconstruction means for reconstructing the object out of them.

11. The apparatus according to claim 10, further comprising:
measuring means for measuring the transmission of the object to obtain measured data.

12. The apparatus according to claim 2, wherein the representation of the object is suited for a computertomographical evaluation.

13. Method for computertomographical reconstruction of an object, comprising:
representing an object according to claim 1 to obtain a representation of the object; and
reconstructing the object based on the representation of the object.

14. Apparatus for computertomographical reconstruction of an object, with an apparatus for representing an object according to claim 2, to obtain a representation of the object; and
means for reconstructing the object based on the representation of the object.
